(19) United States
(12) Patent Application Publication
(10) Pub. No.: US 2021/0208556 A1
(43) Pub. Date: Jul. 8, 2021

(54) METHOD AND DEVICE FOR PROCESSING DATA, AND STORAGE MEDIUM

(71) Applicant: BEIJING XIAOMI MOBILE SOFTWARE CO., LTD., Beijing (CN)

(72) Inventors: Liang WEI, Beijing (CN); Jianfeng TANG, Beijing (CN)

(73) Assignee: BEIJING XIAOMI MOBILE SOFTWARE CO., LTD., Beijing (CN)

(21) Appl. No.: 16/885,336

(22) Filed: May 28, 2020

(30) Foreign Application Priority Data
Jan. 8, 2020 (CN) 202010019016.2

(51) Int. Cl. G05B 19/042

(52) U.S. Cl. CPC G05B 19/042; G05B 2219/25011

(57) ABSTRACT

A method and device for processing data and a storage medium are provided. The method is applied to a control device, and includes that an operation instruction for a state parameter of a controlled device is monitored and a present state parameter of the controlled device is determined responsive to monitoring an operation instruction representing saving of the state parameter. The determined present state parameter is saved as a state parameter in a preset mode.

### CROSS-REFERENCE TO RELATED APPLICATIONS

This application is filed based upon and claims the priority of Chinese patent application No. 202010019016.2, filed on Jan. 8, 2020, the entire contents of which are incorporated herein by reference.

### BACKGROUND

The Internet of Things is an important part of the new generation of information technologies as well as an important development stage of the “information” age. As the name suggests, the Internet of Things is an Internet connecting things. This has two meanings: first, the core and foundation of the Internet of Things are still the Internet, and it is a network extended and expanded based on the Internet; and second, users are extended and expanded to information exchange and communication between any things, namely the things are associated. The Internet of Things is widely applied to network convergence through communication sensing technologies such as intelligent sensing, a recognition technology and pervasive computing, and thus is also called a third wave of development of the world information industry after computer and Internet.

Based on the development of internet of Things technologies, various intelligent devices have emerged. Popularization of intelligent devices brings great convenience to people's lives.

### SUMMARY

The present disclosure generally relates to the technical field of electronics, and more particularly, to a method and device for processing data and a storage medium.

According to a first aspect of the present disclosure, there is provided a method for processing data which may be applied to a control device. The method can include monitoring an operation instruction for a state parameter of the controlled device, and, responsive to monitoring an operation instruction representing saving of the state parameter, determining a present state parameter of the controlled device, and the determined present state parameter is saved as a state parameter in a preset mode.

According to a second aspect of the present disclosure, there is provided a method for processing data which may be applied to a controlled device. The method can include acquiring a state parameter in a preset mode. The state parameter being set and saved for the preset mode responsive to that an operation instruction of saving of the state parameter is monitored by the control device.

According to a third aspect of the present disclosure, there is provided a device for processing data which may be applied to a control device. The device can include monitoring module that is configured to monitor an operation instruction for a state parameter of a controlled device, and a first determination module that is configured to, responsive to monitoring an operation instruction representing saving of the state parameter, determine a present state parameter of the controlled device and save the determined present state parameter as a state parameter in a preset mode.

According to a fourth aspect of the present disclosure, there is provided a device for processing data which may be applied to a controlled device. The device can include a second acquisition module that is configured to acquire a state parameter in a preset mode, the state parameter being set and saved for the preset mode responsive to that an operation instruction of saving of the state parameter is monitored by the control device.

According to a fifth aspect of the present disclosure, there is provided an electronic device that can include a processor and a memory that is configured to store instructions executable for the processor. The processor may be configured to execute the method for processing data of the first aspect or the second aspect.

According to a sixth aspect of the present disclosure, there is provided a storage medium, where instructions in the storage medium may be executed by a processor of a computer to enable the computer to execute the method for processing data of the first aspect or the second aspect.

It should be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate exemplary embodiments consistent with the present disclosure and, together with the description, serve to explain the principles of the present disclosure.

FIG. 1 is a first flow chart showing a method for processing data, according to an exemplary embodiment of the present disclosure.

FIG. 2 is a second flow chart showing a method for processing data, according to an exemplary embodiment of the present disclosure.

FIG. 3 is an interaction flow chart showing a method for processing data, according to an exemplary embodiment of the present disclosure.

FIG. 4 is a first diagram of a device for processing data, according to an exemplary embodiment.

FIG. 5 is a second diagram of a device for processing data, according to an exemplary embodiment.

FIG. 6 is a block diagram of a control device, according to an exemplary embodiment.

FIG. 7 is a block diagram of a controlled device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

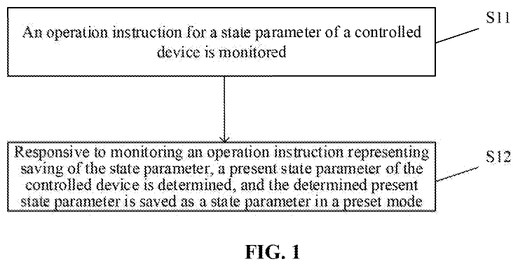

FIG. 1 is a first flow chart showing a method for processing data, according to an exemplary embodiment of the present disclosure. The method for processing data is applied to a control device, and as illustrated in FIG. 1, includes the following steps.

In S11, an operation instruction for a state parameter of a controlled device is monitored.

In S12, responsive to monitoring an operation instruction representing saving of the state parameter, a present state parameter of the controlled device is determined, and the determined present state parameter is saved as a state parameter in a preset mode.

In the embodiment of the present disclosure, the control device refers to a terminal device that may control another Internet of Things device, for example, a smart phone or an intelligent speaker. The controlled device refers to an intelligent home device capable of receiving a control instruction of the control device, for example, an intelligent television and an intelligent air conditioner.

The control device may communicate with the controlled device based on a wireless communication manner or a wired communication manner. The wireless communication manner includes a communication manner based on Wireless Fidelity (Wi-Fi), Bluetooth (BT) and ZigBee, and the like. The wired communication manner includes a Universal Serial Bus (USB)-based communication manner. A communication manner between the control device and the controlled device is not specifically limited in the embodiment of the present disclosure.

It should be noted that, in the embodiment of the present disclosure, that the control device may acquire the state parameter of the controlled device can include that the control device acquires the state parameter of the controlled device based on communication with the controlled device. For example, the state parameter reported by the controlled device is acquired in the BT communication manner. That the control device may acquire the state parameter of the controlled device further includes that the control device acquires the state parameter of the controlled device from a server. For example, a mobile terminal acquires the state parameter of the controlled device from the server connected with the controlled device in the Wi-Fi-based communication manner. That the control device may acquire the state parameter of the controlled device can further include that the control device directly sets the state parameter of the controlled device. For example, the state parameter is sent to the controlled device in the BT communication manner to enable the controlled device to work in a corresponding state.

In the embodiment of the present disclosure, there may be one or more controlled devices. If there are a plurality of controlled devices, when the control device monitors the operation instruction from a user of saving the state parameter, present state parameters of the plurality of controlled device are saved together as the state parameters in the preset mode.

It should be noted that, in the embodiment of the present disclosure, the state parameter of the controlled device refers to a state parameter of the controlled device in a present working state. The state parameter includes, but not limited to, a temperature parameter, a volume parameter, a humidity parameter and the like, and the user may immediately perceive the present working state of the controlled device. When the user perceive that the present working state of the controlled device is an expected state, the control device may monitor the operation instruction of saving the state parameter of the controlled device from the user and save the determined present state parameter as the state parameter in the preset mode, to implement mode recording of the controlled device.

A management Application (APP) for managing the controlled device is installed in the control device. The control device may determine a state parameter of the expected state configured for the controlled device based on a click operation of the user over a “save” control in the management APP or in a manner of receiving a voice control instruction of the user. The state parameter of the expected state is the state parameter in the preset mode.

It should be noted that, in some embodiments, when a plurality of controlled devices in an association relationship are configured in a mode, the operation instruction of saving the state parameter may be a common saving instruction for all state parameters of respective controlled devices. Therefore, responsive to monitoring a saving instruction, state parameters of expected states of the plurality of controlled devices may be configured.

Further, when a plurality of controlled devices in an association relationship are configured in a mode, state parameters of respective controlled devices may be determined one by one for a saving instruction. In the embodiment of the present disclosure, the control device is, for example, a mobile phone, and a home device management APP is installed in the mobile terminal. When the user expects to configure a working state for an intelligent device, for example, a preset mode of a “home mode” is recorded, an intelligent television, intelligent lamp, intelligent curtain, air purifier and intelligent air conditioner to be managed may be turned on, and each intelligent device is manually operated step by step to set each intelligent device to work in expected states according to a real-time feeling of the user. For example, the intelligent curtain is manually set to work in a mode that transmittance is 50%, and the intelligent air conditioner is manually set to work in a mode of 26 DEG C. The home device management APP in the mobile terminal may receive state parameters of present states of these intelligent devices and save the state parameters of respective intelligent devices to complete recording of the “home mode”.

Responsive to monitoring an operation instruction representing setting of the state parameter of the controlled device, the state parameter, indicated by the operation instruction representing setting, of the controlled device in the preset mode can be determined. Further, the determined state parameter is sent to the controlled device, and a working state of the controlled device is set. The controlled device may be controlled based on the state parameter, saved in the control device, belonging to the controlled device in the preset mode to work with the state parameter in the preset mode, such that the working state of the controlled device may be controlled.

Based on recording of the “home mode” by the control device, when the user returns home, the “home mode” may be triggered in the control device, and the state parameter in the “home mode” is sent to the corresponding controlled device, such that the control device may control the working state of the controlled device according to the state parameter in the “home mode”. For example, the controlled device is an intelligent home device. In the “home mode”, the user, after returning home, may turn on the “home mode” based on the control device. The intelligent curtain is set to work in the mode that the transmittance is 50%, and the intelligent air conditioner is set to work in the mode of 26 DEG C.

In the embodiment of the present disclosure, the operation that the control device sets the working state of the controlled device includes that an environmental conditioning device and/or an audio and video entertainment device are/is controlled to be started. The environmental conditioning device may include functions of an intelligent lighting device, a curtain device, an air conditioner, an air purifier and/or a humidifier. The audio and video entertainment device may include a television and/or sound equipment, and the like.

In an embodiment, the method for processing data applied to the control device can further include that, responsive to monitoring an operation instruction representing regulation of the state parameter, the controlled device that the operation instruction representing regulation is for and a regulated state parameter are determined, and the regulated state parameter is sent to the controlled device that the operation instruction is for, and the state parameter in the preset mode is updated according to the regulated state parameter.

In the embodiment, the control device may monitor the operation instruction of regulating the state parameter on the device. The operation instruction of regulation may be for only part of controlled devices in the same mode, or may be for all controlled devices in the same mode. For example, the operation instruction is an instruction of regulating the state parameter of the intelligent air conditioner in the intelligent devices included in the “home mode”. For another example, the operation instruction is an instruction of simultaneously regulating the state parameters of the intelligent curtain and air conditioner included in the “home mode”.

It can be understood that the control device may pertinently regulate, based on a perception of the user, part of controlled devices in the preset mode, such that the effectiveness of regulation may be improved. The control device may simultaneously regulate all controlled devices in the same mode at one time, such that the number of the user's operations may be reduced, and the user experience may be improved.

In the embodiment of the present disclosure, for example, the control device, based on the BT communication manner, receives the state parameter reported by the controlled device. The control device may receive the state parameter actively reported by the controlled device. Of course, the control device may also send a state configuration request instruction to the controlled device and receive the state parameter reported by the controlled device based on the state configuration request instruction. In addition, the control device may receive the state parameter reported by the controlled device based on a set time interval, or may receive the state parameter reported by the controlled device under the condition that the state parameter of the controlled device is changed.

For example, after the control device receives the state parameters actively reported for the nth time by part of controlled devices or all the controlled devices, the control device may display the state parameters or present, in a voice broadcast manner, the state parameters to the user, and receive an operation instruction from the user of regulating the state parameters reported for the nth time. The operation instruction may be a first operation instruction or a second operation instruction. The operation instruction carries regulation parameters, such that the control device may send the regulation parameters to the controlled devices based on an input of the user.

It should be noted that the regulation parameter includes a working parameter that the controlled device is required to be regulated to. The regulation parameter further includes an amplitude parameter by which the regulation needs to be performed based on the state parameter reported for the nth time by the controlled device.

For example, when the temperature parameter reported by the intelligent air conditioner for the second time is 29 DEG C. and the transmittance of the intelligent curtain is 40%, after the home device management APP in the mobile terminal displays the present temperature parameter of the intelligent air conditioner and the transmittance of the intelligent curtain, the mobile terminal, if receiving a regulation parameter 26 DEG C. for the intelligent air conditioner input by the user based on the home device management APP, may send the temperature regulation parameter 26 DEG C. to the intelligent air conditioner, or, if receiving a regulation amplitude parameter of decreasing by 3 DEG C. for the intelligent air conditioner input by the user based on the home device management APP, may send the regulation amplitude parameter of decreasing by 3 DEG C. to the intelligent air conditioner.

For another example, when the temperature parameter of the intelligent air conditioner is 25 DEG C. and the transmittance of the intelligent curtain is 40%, after the home device management APP in the mobile terminal displays the present temperature parameter of the intelligent air conditioner and the transmittance of the intelligent curtain, an instruction, input by the user at one time based on the home device management APP, of increasing the parameters of the controlled devices in the preset “home mode” by one level may be received. In such case, the home device management APP in the mobile terminal, based on the unified regulation instruction, may determine the regulation parameter 26 DEG C. of the intelligent air conditioner and the transmittance 50% of the intelligent curtain, send the temperature regulation parameter 26 DEG C. to the intelligent air conditioner and send the transmittance parameter 50% to the intelligent curtain.

In the embodiment of the present disclosure, based on the state parameter received for the nth time, the control device may further receive a state parameter reported for the (n+1)th time by the controlled device after the controlled device regulates the state based on the regulation parameter. Or, the control device may determine the present state parameter of the controlled device according to the state parameter reported for the nth time by the control device and the regulation parameter.

In the embodiment, the control device, after sending the regulation parameter to the controlled device, may receive from the controlled device the state parameter reported for the (n+1)th time by the controlled device after the controlled device regulates the state based on the regulation parameter, i.e., the updated present state parameter of the controlled device. For example, the mobile terminal may receive 26 DEG C. reported for the (n+1)th time by the intelligent air conditioner after the intelligent air conditioner regulates the state.

In the embodiment of the present disclosure, since the control device may send the regulation parameter based on the received state parameter which is reported for the nth time by the controlled device, the control device may also determine the present state parameter of the controlled device based on its own regulation over the controlled device. For example, the home device management APP in the mobile terminal may determine that the present temperature parameter of the air conditioner is 26 DEG C. according to the temperature parameter 29 DEG C. reported for the second time by the intelligent air conditioner and the received regulation amplitude parameter of decreasing by 3 DEG C. input by the user based on the home device management APP.

It can be understood that, in the embodiment of the present disclosure, the control device may regulate the state parameters of part of controlled devices or all the controlled devices in the preset mode to control the working states of the controlled devices, such that the controlled devices may gradually tend to work in the states expected by the user, to implement determination of the state parameters of the expected states.

In an embodiment, the method for processing data applied to the control device can further include that the state parameter which has been regulated by the controlled device based on the regulation instruction for the controlled device is received, and the state parameter in the preset mode is updated according to the regulated state parameter. In the embodiment, the state parameter of the controlled device is not limited to be regulated and sent through the control device. The controlled device may also determine the present state parameter based on a monitored operation of the user over the controlled device, and report the state parameter to the control device. For example, the intelligent air conditioner, after monitoring a click operation of the user over a temperature control on a Touch Panel (TP), regulates the present state parameter and reports the regulated state parameter to the control device.

In an embodiment, the method for processing data further includes determining whether a configuration of the preset mode is turned on, and under the condition that the configuration of the preset mode is turned on, the state parameter of the controlled device is acquired.

In the embodiment, the control device, under the condition that the configuration of the preset mode is turned on, acquires the state parameter of the controlled device. Whether the configuration of the preset mode is turned on is set by the user. When the user is intended to configure a state parameter of an ideal state for the controlled device, namely the user is intended to record a mode, the configuration of the preset mode in the control device may be set to be turned on.

Under the condition that the configuration of the preset mode is turned on, the control device may send a state configuration request instruction to the controlled device to acquire the state parameter sent by the controlled device based on the state configuration request instruction. Under the condition that the configuration of the preset mode is turned on, the control device may also directly synchronize the state parameter, on the server side, of the controlled device. In the embodiment, under the condition that the configuration of the preset mode is turned on, namely the state parameter of the controlled device is only acquired under the condition that the user has requirements of mode recording, such that unnecessary instruction interactions are reduced, and the power consumption of the control device is reduced.

In the embodiment of the present disclosure, the control device may monitor the operation instruction for the state parameter of the controlled device. When a user determines, based on the working state of the controlled device, that the state parameter is required to be saved, the control device may receive the operation instruction of saving the state parameter, and the control device may save, based on the operation instruction of saving, the determined present state parameter of the controlled device as the state parameter in the preset mode. In the process, the present state parameter is saved for the preset mode based on an intuitive feeling of the user and responsive to monitoring the operation instruction of saving the state parameter from the user, thereby implementing the recording of the state parameter in the mode. It can be understood that, in the manner of recording the state parameter of the controlled device in the preset mode in the present disclosure, saving is confirmed based on the intuitive feeling of the user, such that the probability of repeated operation and setting which is caused by the fact that a true feeling of the user is not considered is reduced, and the user experience is improved.

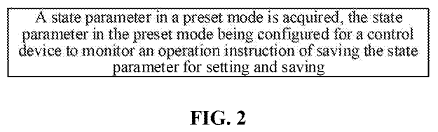

FIG. 2 is a second flow chart showing a method for processing data, according to an embodiment of the present disclosure. The method for processing data is applied to a controlled device, and as illustrated in FIG. 2, the method includes the following step.

In S21, a state parameter in a preset mode is acquired, the state parameter in the preset mode being configured for a control device to monitor an operation instruction of saving the state parameter for setting and saving.

In the embodiment, the controlled device refers to an intelligent home device capable of receiving a control instruction of the control device, for example, an intelligent television and an intelligent air conditioner. The controlled device may communicate with the control device based on a wireless communication manner or a wired communication manner.

In the embodiment of the present disclosure, the controlled device may acquire the state parameter in the preset mode, such that the control device sets and saves the state parameter for the preset mode responsive to monitoring the operation instruction of saving the state parameter.

It should be noted that, in the embodiment of the present disclosure, the operation that the controlled device acquires the state parameter in the preset mode includes that the controlled device acquires the state parameter in the preset mode based on a monitored operation of a user over the controlled device, and further includes that the controlled device receives the state parameter in the preset mode sent by the control device.

In addition, in the embodiment of the present disclosure, the operation that the controlled device acquires the state parameter in the preset mode includes that the control device acquires the state parameter in the preset mode for the First time, and further includes that the controlled device receives a regulated state parameter in the preset mode.

In an embodiment, the method for processing data applied to the controlled device further includes that the state parameter updated by the control device in the preset mode is received, and the updated state parameter in the preset mode is saved.

In a recording stage of the preset mode, the state parameter in the preset mode may be a regulated state parameter sent by the control device. The controlled device, after receiving the state parameter, may save and update it to the preset mode. The state parameter may be a regulated state parameter, sent by the control device based on monitoring an operation instruction representing regulation, in the preset mode.

In an embodiment, the operation that the state parameter in the preset mode is acquired includes that the state parameter in the preset mode sent by the control device is received, or a present state parameter of the controlled device is reported, and responsive to a confirmation instruction sent by the control device, the present state parameter is determined as the state parameter in the preset mode.

In the embodiment, the controlled device may receive the state parameter in the preset mode sent by the control device. After the setting of preset mode is completed, the user may start a saved mode based on an operation over the control device, namely the state parameter in the saved preset mode may be sent to the controlled device. The controlled device saves the updated state parameter in the preset mode according to the received state parameter in the preset mode, and the controlled device works according to the state parameter in the preset mode.

For example, based on recording of a “home mode” by the control device, when the user returns home, the “home mode” may be triggered in the control device, the state parameter in the “home mode” is sent to the corresponding controlled device. The controlled device may save the state parameter in the preset mode and works according to the state parameter in the mode.

In the embodiment, the controlled device, after reporting the present state parameter to the control device, may also determine the present state parameter as the state parameter in the preset mode based on determination of the control device. It should be noted that, in the embodiment, the controlled device may actively report the state parameter to the control device. The controlled device may report the state parameter based on a set time interval, or may report a changed state parameter to the control device responsive to detecting that the state parameter is changed.

In the embodiment of the present disclosure, the controlled device may acquire the state parameter in the preset mode such that the control device saves the state parameter for the preset mode. In this process, the probability of repeated operation and setting which is caused by the fact that a true feeling of the user is not considered is reduced, and thus the user experience may be improved.

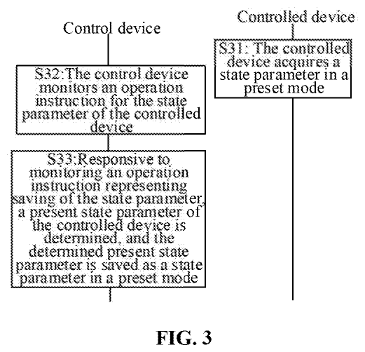

FIG. 3 is an interaction flow chart showing a method for processing data, according to an exemplary embodiment of the present disclosure. As illustrated in FIG. 3, the method for processing data applied to a control device and a controlled device includes the following steps.

In S31, the controlled device acquires a state parameter in a preset mode.

In S32, the control device monitors an operation instruction for the state parameter of the controlled device.

In S33, responsive to monitoring an operation instruction representing saving of the state parameter, a present state parameter of the controlled device is determined, and the determined present state parameter is saved as a state parameter in a preset mode.

In the embodiment of the present disclosure, the control device may monitor the operation instruction for the state parameter of the controlled device. When a user determines, based on the working state of the controlled device, that the state parameter is required to be saved, the control device may receive the operation instruction of saving the state parameter, and the control device may save, based on the operation instruction of saving, the determined present state parameter of the controlled device as the state parameter in the preset mode. In the process, the present state parameter is saved for the preset mode based on an intuitive feeling of the user responsive to monitoring the operation instruction of saving the state parameter from the user, thereby implementing the recording of the state parameter in the mode. It can be understood that, in the manner of recording the state parameter of the controlled device in the preset mode in the present disclosure, saving is confirmed based on the intuitive feeling of the user, such that the probability of repeated operation and setting which is caused by the fact that a true feeling of the user is not considered is reduced, and the user experience is improved.

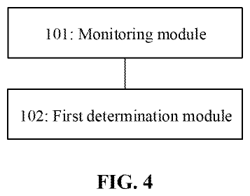

FIG. 4 is a first diagram of a device for processing data, according to an exemplary embodiment. Referring to FIG. 4, the device for processing data is applied to a control device. The device for processing data can include a monitoring module 101 that is configured to monitor an operation instruction for a state parameter of a controlled device, and a first determination module 102 that is configured to, responsive to monitoring an operation instruction representing saving of the state parameter, determine a present state parameter of the controlled device and save the determined present state parameter as a state parameter in a preset mode.

Optionally, the device can further include a second determination module 103, configured to, responsive to monitoring an operation instruction representing setting of the state parameter of the controlled device, determine the state parameter, indicated by the operation instruction representing setting, of the controlled device in the preset mode, and a first sending module 104 that is configured to send the determined state parameter to the controlled device and set a working state of the controlled device.

Additionally, the device can further include a third determination module 105 that is configured to, responsive to monitoring an operation instruction representing regulation of the state parameter, determine the controlled device that the operation instruction representing regulation is for and a regulated state parameter, and a second sending module 106 that is configured to send the regulated state parameter to the controlled device that the operation instruction is for and update the state parameter in the preset mode according to the regulated state parameter.

The device can further include a first receiving module 107 that is configured to receive the state parameter which has been regulated by the controlled device based on a regulation instruction for the controlled device, and an updating module 108 that is configured to update the state parameter in the preset mode according to the regulated state parameter.

Optionally, the device can further include a fourth determination module 109 that is configured to determine whether a configuration of the preset mode is turned on, and a first acquisition module 110 that is configured to, under the condition that the configuration of the preset mode is turned on, acquire the state parameter of the controlled device.

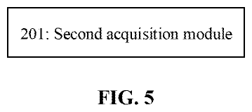

FIG. 5 is a second diagram of a device for processing data, according to an exemplary embodiment. Referring to FIG. 5, the device for processing data is applied to a controlled device. The device for processing data includes a second acquisition module 201 that is configured to acquire a state parameter in a preset mode, the state parameter in the preset mode being configured for a control device to monitor an operation instruction of saving the state parameter for setting and saving.

The device can further include a second receiving module 202 that is configured to receive the state parameter updated by the control device in the preset mode, and a saving module 203 that is configured to save the updated state parameter in the preset mode.

Optionally, the device can further include a second acquisition module 201 that is specifically configured to receive the state parameter in the preset mode sent by the control device, or report a present state parameter of the controlled device and, responsive to a confirmation instruction sent by the control device, determine the present state parameter as the state parameter in the preset mode.

With respect to the device in the above embodiment, the specific manners for respective modules performing operations therein have been described in detail in the embodiment regarding the method, which will not be elaborated herein.

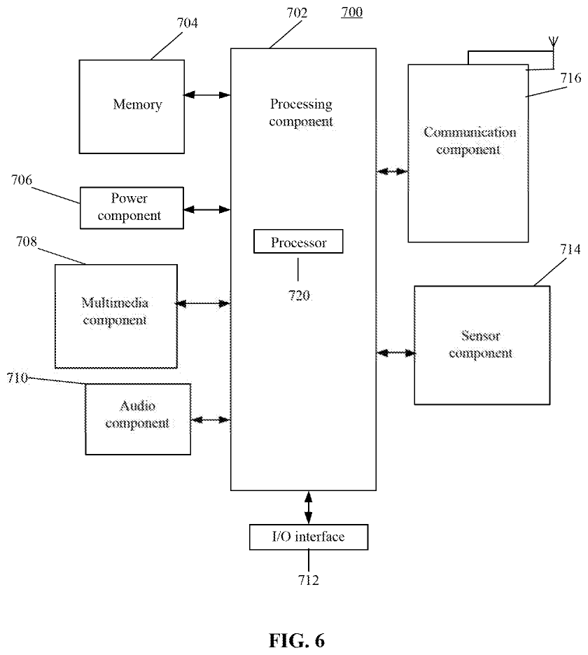

FIG. 6 is a block diagram of a control device, according to an exemplary embodiment. For example, the control device 700 may be an intelligent speaker or a smart phone. As shown in FIG. 6, the control device 700 may include one or more of the following components: a processing component 702, a memory 704, a power component 706, a multimedia component 708, an audio component 710, an Input/Output (I/O) interface 712, a sensor component 714, and a communication component 716.

The processing component 702 typically controls overall operations of the control device 700, such as the operations associated with display, telephone calls, data communications, camera operations, and recording operations. The processing component 702 may include one or more processors 720 to execute instructions to perform all or part of the steps in the abovementioned method. Moreover, the processing component 702 may include one or more modules which facilitate interaction between the processing component 702 and other components. For example, the processing component 702 may include a multimedia module to facilitate interaction between the multimedia component 708 and the processing component 702.

The memory 704 is configured to store various types of data to support the operation on the control device 700. Examples of such data include instructions for any APPs or methods operated on the control device 700, contact data, phonebook data, messages, pictures, video, etc. The memory 704 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 706 provides power for various components of the control device 70. The power component 806 may include a power management system, one or more power supplies, and other components associated with generation, management and distribution of power for the control device 700.

The multimedia component 708 includes a screen providing an output interface between the control device 700 and a user. In some embodiments, the screen may include a Liquid Crystal Display (LCD) and a TP. If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 708 includes a front camera and/or a rear camera. The front camera and/or the rear camera may receive external multimedia data when the control device 700 is in an operation mode, such as a photographing mode or a video mode. Each of the front camera and the rear camera may be a fixed optical lens system or have focusing and optical zooming capabilities.

The audio component 710 is configured to output and/or input an audio signal. For example, the audio component 710 includes a Microphone (MIC). The MIC is configured to receive an external audio signal when the control device 700 is in the operation mode, such as a call mode, a recording mode and a voice recognition mode. The received audio signal may further be stored in the memory 704 or sent through the communication component 716. In some embodiments, the audio component 710 further includes a speaker which is configured to output the audio signal.

The I/O interface 712 provides an interface between the processing component 702 and a peripheral interface module. The peripheral interface module may be a keyboard, a click wheel, a button and the like. The button may include, but not limited to a home button, a volume button, a starting button, and a locking button.

The sensor component 714 includes one or more sensors which is configured to provide status assessment in various aspects for the control device 700. For example, the sensor component 714 may detect an on/off status of the control device 700 and relative positioning of components, such as a display and small keyboard of the control device 700. The sensor component 714 may further detect a change in a position of the control device 700 or a component of the control device 700, presence or absence of contact between the user and the control device 700, orientation or acceleration/deceleration of the control device 700 and a change in temperature of the control device 700. The sensor component 714 may include a proximity sensor which is configured to detect presence of an object nearby without any physical contact. The sensor component 714 may also include a light sensor, such as a Complementary Metal Oxide Semiconductor (CMOS) or Charge Coupled Device (CCD) image sensor, which is configured to be used in an imaging APP. In some embodiments, the sensor component 714 may also include an acceleration sensor, a gyroscope sensor, a magnetic sensor, a pressure sensor or a temperature sensor.

The communication component 716 is configured to facilitate wired or wireless communication between the control device 700 and other devices. The control device 700 may access a communication-standard-based wireless network, such as a Wi-Fi network, a 2nd-Generation (2G) or 3rd-Generation (3G) network or a combination thereof. In an exemplary embodiment, the communication component 716 receives a broadcast signal or broadcast associated information from an external broadcast management system through a broadcast channel. In an exemplary embodiment, the communication component 716 further includes a Near Field Communication (NFC) module to facilitate short-range communication. For example, the NFC module may be implemented based on a Radio Frequency Identification (RFD) technology, an Infrared Data Association (IrDA) technology, an Ultra-Wide Band (UWB) technology, a BT technology and other technologies.

In an exemplary embodiment, the control device 700 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and the control device 700 is configured to execute the abovementioned method.

In an exemplary embodiment, there is also provided a non-transitory computer-readable storage medium including instructions, for example, the memory 704 including instructions. The instructions may be executed by the processor 720 of the control device 700 to implement the abovementioned method. For example, the non-transitory computer-readable storage medium may be a ROM, a Random Access Memory (RAM), a Compact Disc Read-Only Memory (CD-ROM), a magnetic tape, a floppy disc, an optical data storage device and the like.

According to a non-transitory computer-readable storage medium, instructions in the storage medium can be executed by a processor of a control device to enable the control device to execute a method for processing data. The method can include that an operation instruction for a state parameter of a controlled device is monitored, and, responsive to monitoring an operation instruction representing saving of the state parameter, a present state parameter of the controlled device is determined, and the determined present state parameter is saved as a state parameter in a preset mode.

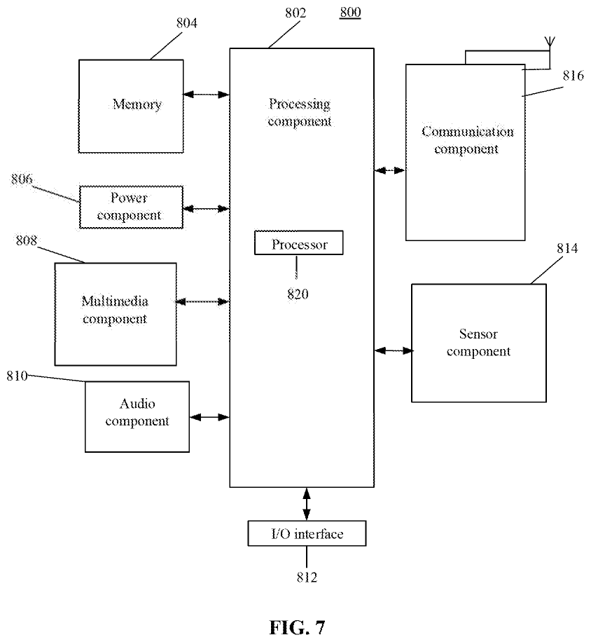

FIG. 7 is a block diagram of a controlled device 800, according to an exemplary embodiment. For example, the controlled device 800 may be an intelligent air conditioner and an intelligent washing machine. As shown in FIG. 7, the controlled device 800 may include one or more of the following components: a processing component 802, a memory 804, a power component 806, a multimedia component 808, an audio component 810, an 1/O interface 812, a sensor component 814, and a communication component 816.

The processing component 802 typically controls overall operations of the controlled device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and other components. For example, the processing component 802 may include a multimedia module to facilitate interaction between the multimedia component 808 and the processing component 802.

The memory 804 is configured to store various types of data to support the operation on the controlled device 800. Examples of such data include instructions for any APPs or methods operated on the controlled device 800, contact data, phonebook data, messages, pictures, video, etc. The memory 804 may be implemented by any type of volatile or non-volatile memory devices, or a combination thereof such as an SRAM, an EEPROM, an EPROM, a PROM, a ROM, a magnetic memory, a flash memory, and a magnetic or optical disk.

The power component 806 provides power for various components of the controlled device 8A. The power component 806 may include a power management system, one or more power supplies, and other components associated with generation, management and distribution of power for the controlled device 800.

The multimedia component 808 includes a screen providing an output interface between the controlled device 800 and a user. In some embodiments, the screen may include an LCD and a TP. If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 808 includes a front camera and/or a rear camera. The front camera and/or the rear camera may receive external multimedia data when the controlled device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a MIC. The MIC is configured to receive an external audio signal when the controlled device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module. The peripheral interface module may be a keyboard, a click wheel, a button and the like. The button may include, but not limited to a home button, a volume button, a starting button, and a locking button.

The sensor component 814 includes one or more sensors which is configured to provide status assessment in various aspects for the controlled device 800. For example, the sensor component 814 may detect an on/off status of the controlled device 800 and relative positioning of components, such as a display and small keyboard of the controlled device 800. The sensor component 814 may further detect a change in a position of the controlled device 800 or a component of the controlled device 80, presence or absence of contact between the user and the controlled device 800, orientation or acceleration/deceleration of the controlled device 800 and a change in temperature of the controlled device 800. The sensor component 814 may include a proximity sensor which is configured to detect presence of an object nearby without any physical contact. The sensor component 814 may also include a light sensor, such as a CMOS or CCD image sensor, which is configured to be used in an imaging APP. In some embodiments, the sensor component 814 may also include an acceleration sensor, a gyroscope sensor, a magnetic sensor, a pressure sensor or a temperature sensor.

The communication component 816 is configured to facilitate wired or wireless communication between the controlled device 800 and other devices. The controlled device 800 may access a communication-standard-based wireless network, such as a Wi-Fi network, a 2G or 3G network or a combination thereof. In an exemplary embodiment, the communication component 816 receives a broadcast signal or broadcast associated information from an external broadcast management system through a broadcast channel. In an exemplary embodiment, the communication component 816 further includes an NFC module to facilitate short-range communication. For example, the NFC module may be implemented based on an RFID technology, an IrDA technology, a UWB technology, a BT technology and other technologies.

In an exemplary embodiment, the controlled device 800 may be implemented by one or more ASCs, DSPs, DSPDs, PLDs, FPGAs, controllers, micro-controllers, microprocessors or other electronic components, and the controlled device 800 is configured to execute the abovementioned method.

In an exemplary embodiment, there is also provided a non-transitory computer-readable storage medium including instructions, for example, the memory 804 including instructions. The instructions may be executed by the processor 820 of the controlled device 800 to implement the abovementioned method. For example, the non-transitory computer-readable storage medium may be a ROM, a RAM, a CD-ROM, a magnetic tape, a floppy disc, an optical data storage device and the like.

According to a non-transitory computer-readable storage medium, instructions in the storage medium is executed by a processor of a controlled device to enable the controlled device to execute a method for processing data, the method including that a state parameter in a preset mode is acquired, the state parameter in the preset mode being configured for a control device to monitor an operation instruction of saving the state parameter for setting and saving.

Other implementation solutions of the present disclosure will be apparent to those skilled in the art from consideration of the specification and practice of the present disclosure. This present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It should be understood that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A method for processing data that is applied to a control device, the method comprising:
monitoring an operation instruction for a state parameter of a controlled device; and
determining a present state parameter of the controlled device responsive to monitoring an operation instruction representing saving of the state parameter and saving the determined present state parameter as a state parameter in a preset mode.

2. The method of claim 1, further comprising:
determining the state parameter, indicated by an operation instruction representing setting, of the controlled device in the preset mode responsive to monitoring an operation instruction representing setting of the state parameter of the controlled device; and
sending the determined state parameter to the controlled device and setting a working state of the controlled device.

3. The method of claim 1, further comprising:
determining which controlled device that an operation instruction representing regulation is for, and a regulated state parameter responsive to monitoring an operation instruction representing regulation of the state parameter; and
sending the regulated state parameter to the controlled device that the operation instruction representing regulation is for, and updating the state parameter in the preset mode according to the regulated state parameter.

4. The method of claim 1, further comprising:
receiving the state parameter which has been regulated by the controlled device based on a regulation instruction for the controlled device; and
updating the state parameter in the preset mode according to the regulated state parameter.

5. The method of claim 1, further comprising:
determining whether a configuration of the preset mode is turned on; and
acquiring the state parameter of the controlled device when the configuration of the preset mode is turned on.

6. A method for processing data that is applied to a controlled device, the method comprising:
acquiring a state parameter in a preset mode, the state parameter being set and saved for the preset mode responsive to an operation instruction of saving of the state parameter being monitored by the control device.

7. The method of claim 6, further comprising:
receiving the state parameter updated by the control device in the preset mode; and
saving the updated state parameter in the preset mode.

8. The method of claim 6, wherein acquiring the state parameter in the preset mode further comprises:
receiving the state parameter in the preset mode sent by the control device; or
reporting a present state parameter of the controlled device, and, responsive to a confirmation instruction sent by the control device, determining the present state parameter as the state parameter in the preset mode.

9. A device for processing data that is applied to a control device, the device comprising:
a processor; and
a memory that is configured to store instructions executable for the processor,
wherein the processor is configured to:
monitor an operation instruction for a state parameter of a controlled device, and
determine a present state parameter of the controlled device and save the determined present state parameter as a state parameter in a preset mode responsive to monitoring an operation instruction representing saving of the state parameter.

10. The device of claim 9, wherein the processor is further configured to:
determine the state parameter indicated by the operation instruction representing setting of the controlled device in the preset mode responsive to monitoring an operation instruction representing setting of the state parameter of the controlled device; and
send the determined state parameter to the controlled device and set a working state of the controlled device.

11. The device of claim 9, wherein the processor is further configured to:
determine the controlled device that the operation instruction representing regulation is for and a regulated state parameter, responsive to monitoring an operation instruction representing regulation of the state parameter; and
send the regulated state parameter to the controlled device that the operation instruction representing regulation is for and update the state parameter in the preset mode according to the regulated state parameter.

12. The device of claim 9, wherein the processor is further configured to:
receive the state parameter which has been regulated by the controlled device based on a regulation instruction for the controlled device; and
update the state parameter in the preset mode according to the regulated state parameter.

13. The device of claim 9, wherein the processor is further configured to:
determine whether a configuration of the preset mode is turned on; and
acquire the state parameter of the controlled device under when the configuration of the preset mode is turned on.

14. A device for processing data that is applied to a controlled device, the device comprising:
a processor; and
a memory that is configured to store instructions executable by the processor, wherein the processor is configured to:
acquire a state parameter in a preset mode, the state parameter being set and saved for the preset mode responsive to that an operation instruction of saving of the state parameter is monitored by the control device.

15. The device of claim 14, wherein the processor is further configured to:
receive the state parameter updated by the control device in the preset mode; and
save the updated state parameter in the preset mode.

16. The device of claim 14, wherein the processor is configured to:
receive the state parameter in the preset mode sent by the control device or report a present state parameter of the controlled device, and
determine the present state parameter as the state parameter in the preset mode responsive to a confirmation instruction sent by the control device.

17. A non-transitory computer-readable storage medium, instructions in the storage medium being executed by a processor of a computer to enable the computer to execute the method for processing data of claim 1.
